(19) United States
(12) Patent Application Publication
(10) Pub. No.: US 2025/0382839 A1
(43) Pub. Date: Dec. 18, 2025

(54) WINDOW SAFETY DEVICE

(71) Applicant: CLEAN UR AIR LIMITED LIABILITY COMPANY, Cement City, MI (US)

(72) Inventor: Robinson SCOTT, Cement City, MI (US)

(21) Appl. No.: 19/240,942

(22) Filed: Jun. 17, 2025

Related U.S. Application Data
(60) Provisional application No. 63/661,387, filed on Jun. 18, 2024.

(51) Int. Cl. E06B 7/28; B01D 46/00; F04D 29/52; G08B 13/08; G08B 21/20

(52) U.S. Cl. CPC E06B 7/28; B01D 46/0039; B01D 46/0091; F04D 29/522; G08B 13/08; G08B 21/20; B01D 2273/30; B01D 2279/50

(57) ABSTRACT

A versatile and customizable air purification and security system is provided and designed for integration with various openings such as windows and doors. The system is provided with a robust frame that can be constructed from materials including steel, aluminum, composite materials, wood, PVC, or carbon fiber, ensuring adaptability to different environments and durability requirements. The frame is securely attached using a variety of brackets and retainers. A hinged door, made from materials such as steel, aluminum, wood, glass, acrylic, or polycarbonate, incorporates custom artwork and cutouts for aesthetic and functional purposes, including airflow and natural light passage.

### CROSS-REFERENCE TO RELATED APPLICATIONS

This application claims the benefit of U.S. provisional application Ser. No. 63/661,387 filed Jun. 18, 2024, the disclosure of which is hereby incorporated in its entirety by reference herein.

### TECHNICAL FIELD

Aspects of the disclosure relate to a window safety device.

### BACKGROUND

Air purification systems and home security devices are widely used in residential and commercial settings to ensure a healthy and safe indoor environment. Traditional air purification systems are often standalone units designed to filter indoor air, removing contaminants such as dust, pollen, smoke, and other airborne particles. On the other hand, home security systems typically consist of alarms, sensors, and monitoring devices that provide protection against unauthorized entry, theft, and environmental hazards. Windows and doors are essential components of building structures, providing natural light, ventilation, and access control. Several attempts have been made to combine air purification with window or door structures.

### SUMMARY

In one aspect of the disclosure, a window security device is provided with a frame made of a material selected from the group consisting of steel and other materials. The frame is configured to attach to an opening using a sealing material selected from the group consisting of rubber, foam, and similar materials. The device further includes an adjustable filler piece made of a material selected from the group consisting of steel and similar materials, the adjustable filler piece being configured to conform to odd-sized openings. A side retainer bracket made of a material selected from the group consisting of steel and similar strength materials is used to attach and reinforce the frame to a sash or any structural opening's framework. Two latches are configured to keep the frame and a door latched and locked together for added safety. A window stop made of a material selected from the group consisting of steel and similar strength materials is configured to prevent the lower window from opening. Hinges are provided to allow the door to swing open, with the hinges being attached to the frame and the door. The door is made of a material selected from the group consisting of steel and similar strength materials and has a display of artwork, cutouts allowing fresh air and natural light to pass through, and a foam-type sealing material configured to restrict air flow between the door and the frame. A fan retainer is attached to the door, the fan retainer being configured to hold a fan in place and create a cavity between the door and the fan. A motion alarm is attached to the door, the motion alarm being configured to alert occupants of possible break-ins or severe weather, the motion alarm being powered by a solar panel or other power sources. A variable speed fan assembly is configured to be attached to the fan retainer and increase air flow if desired. A window retainer is attached to the back of the frame, the window retainer being made in various sizes, shapes, and types of materials to retain the frame to window run channels. Retainer hooks are attached to the door, the retainer hooks being configured to allow a box fan to be hung instead of another fan.

In another aspect of the disclosure, a door security and air purification system is provided with a frame attachable to an opening using brackets and a lower bracket configured to lock a lower window shut. A door is attachable to the frame using hinges, the door being made of a material selected from the group consisting of steel and similar strength materials and having a display of artwork. A motion sensor alarm is attached to the door, the motion sensor alarm being configured to alert via Bluetooth® telecommunication to mobile devices. A custom fit fan is attached to the door, the fan having features for controlling temperature, humidity, and on-off switching, and being attached to a fan retainer creating a pocket behind the door. Materials and lighting schemes are attachable within the pocket to change the appearance of the artwork or to filter air passing through the door. A fan hanger is configured to retain a box fan within the pocket.

The window security device, wherein the frame is further provided with a rubber or foam material for additional sealing. The window security device, wherein the adjustable filler piece is configured to be adjusted manually to fit various opening sizes. The window security device, wherein the motion alarm is configured to produce an audible sound upon detecting motion. The window security device is further provided with a humidity sensor configured to alert occupants when it is raining outside. The window security device, wherein the solar panel is configured to be attached to any flat surface using suction cups or hooks. The window security device, wherein the cavity between the door and the fan is adjustable to a depth between 1 inch and 4 inches. The window security device is further provided with a filter attachable within the cavity for purifying air passing through the door. The door security and air purification system, wherein the fan is configured to be detachable from the fan retainer. The door security and air purification system, wherein the door includes cutouts to allow additional natural light to pass through. The door security and air purification system is further provided with a solar panel configured to power the motion sensor alarm.

### BRIEF DESCRIPTION OF THE DRAWINGS

FIG. 1 is a security system according to one or more aspects of the disclosure;

FIG. 2 is a security system according to one or more aspects of the disclosure;

FIG. 3 is an enlarged view of a retainer block of the security system of FIG. 1;

FIG. 4 is an enlarged view of retainers of the security system of FIG. 1;

FIG. 5 is an enlarged view of a solar panel of the security system of FIG. 1;

FIG. 6 is a front view of a frame of the security system of FIG. 1;

FIG. 7 is an enlarged view of retainers of the security system of FIG. 1;

FIG. 8 is an enlarged view of a side filler of the security system of FIG. 1;

FIG. 9 is a front view of a door of the security system of FIG. 1;

FIG. 10 is an enlarged view of a retainer of the security system of FIG. 1;

FIG. 11 is a front view of a fan for cooperation with the security system of FIG. 1; and

FIG. 12 is a front view of an artwork panel of the security system of FIG. 1, according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Prior art air purification systems generally require floor or wall space and do not integrate with existing structural elements like windows or doors, limiting their aesthetic appeal and space efficiency. Prior art home security systems are usually installed independently of air purification units and focus solely on security functions, such as detecting motion, break-ins, or environmental threats like smoke and carbon monoxide. While effective in their respective domains, traditional air purification and security systems operate separately, necessitating multiple installations and higher costs for comprehensive home safety and air quality management.

Standard window and door systems are primarily designed for basic functions, such as opening and closing, without incorporating advanced features like air purification or environmental sensing. This limitation often requires homeowners to rely on separate devices for air quality improvement and security, resulting in cluttered spaces and complex management.

Window-mounted air purifiers have been developed to filter incoming air, but these solutions typically lack integration with security features and advanced environmental monitoring. Similarly, some security systems have integrated basic environmental sensors, yet they do not address air purification needs effectively.

With the growing adoption of smart home technologies, there is an increasing demand for integrated solutions that combine multiple functionalities into a single, cohesive system. These smart systems aim to enhance user convenience by providing centralized control over various aspects of home management, including air quality, security, and environmental comfort. Despite the advancements in smart home devices, there remains a gap in the market for a system that seamlessly integrates air purification, security, and smart home features within existing window and door frameworks.

Clean air systems can be custom-made to fit any opening, window frame, or door with openings. It is designed to attach to the opening of any kind of framework, adding extra strength to an already existing opening. The frame of the system can be made of various materials, such as steel for its strength and durability, aluminum for its lightweight and corrosion-resistant properties, or composite materials like fiberglass, plastic, and resins which provide strength and weather resistance. Wood, with its natural insulating properties and aesthetic appeal, or polyvinyl chloride (PVC), known for its durability and low maintenance, can also be used. For high-end applications, carbon fiber may be utilized due to its superior strength and lightweight characteristics. The frame is attached using several types of brackets, including side retainers, window retainers, or direct attachments to any framework or window. At the bottom of the frame, a lower bracket made of undetermined materials holds the lower window locked shut. Once the frame is secured, the door, which can also be made of steel, aluminum, wood, glass, acrylic, or polycarbonate for different benefits, is attached using various types of hinges.

Hinges can include butt hinges, which are commonly used for doors; continuous hinges (piano hinges) that run the entire length of the door, providing uniform strength; concealed hinges (European hinges), often used in cabinetry for a clean look; pivot hinges, which allow doors to pivot from a point on the top and bottom of the door; spring hinges that contain a spring for automatic closing; barrel hinges for smaller doors or cabinets; flush hinges that lie flush with the door and frame surfaces; and strap hinges with long leaves, often decorative and used on gates or barn doors.

The door comes with artwork of any custom design and is equipped with a motion sensor alarm with Bluetooth® telecommunication, alerting the user and mobile devices of the user, of any movement. Bluetooth® is a registered trademark of BLUETOOTH SIG, INC., a corporation of Delaware, residing at Suite 350, 5209 Lake Washington Boulevard, Kirkland, Washington 98033, United States of America. Bluetooth® telecommunication technology allows for wireless communication over short distances, ensuring real-time alerts. A custom-fit fan, featuring temperature, humidity, and on/off switches, is added to draw in fresh, clean air. This fan is attached to a fan retainer at the back of the door, creating a pocket that can house different color materials, lights to change the artwork's appearance, or a filter to remove airborne particles and odors. Fan hangers can be added to accommodate a twenty inch by twenty inch box fan if desired.

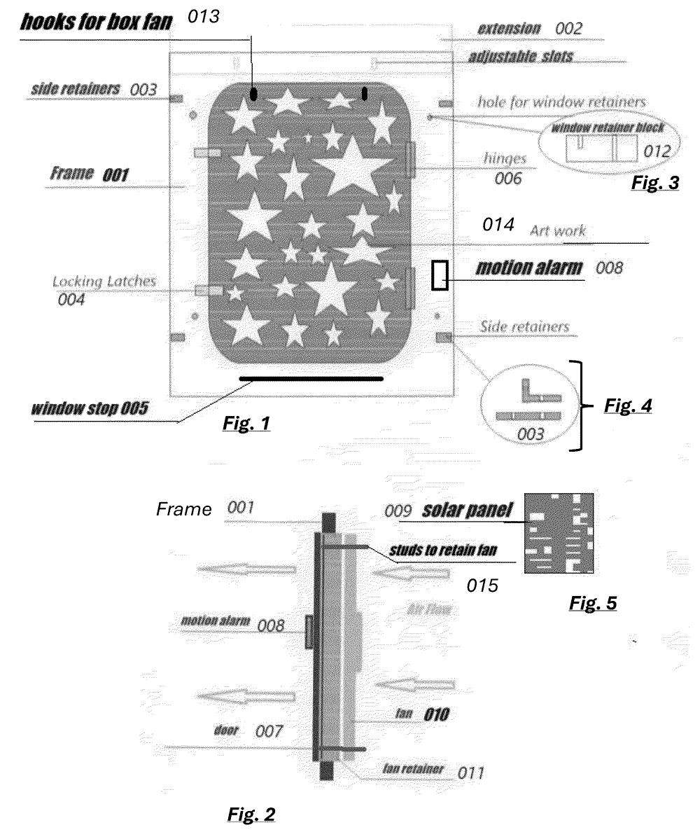

The window security device not only protects the user's home but also allows for personalized artwork and purifies the air passing through it. Referring now to FIGS. 1, 2, and 6, the system includes a frame 001 made of steel or other materials such as aluminum, composite materials, wood, PVC, or carbon fiber. The frame attaches to any opening with a sealing material like rubber, foam, or silicone, providing excellent flexibility, sealing properties, and resistance to weathering. An adjustable filler piece 002 (FIGS. 1 and 8) of steel or similar material is added to conform to odd-size openings.

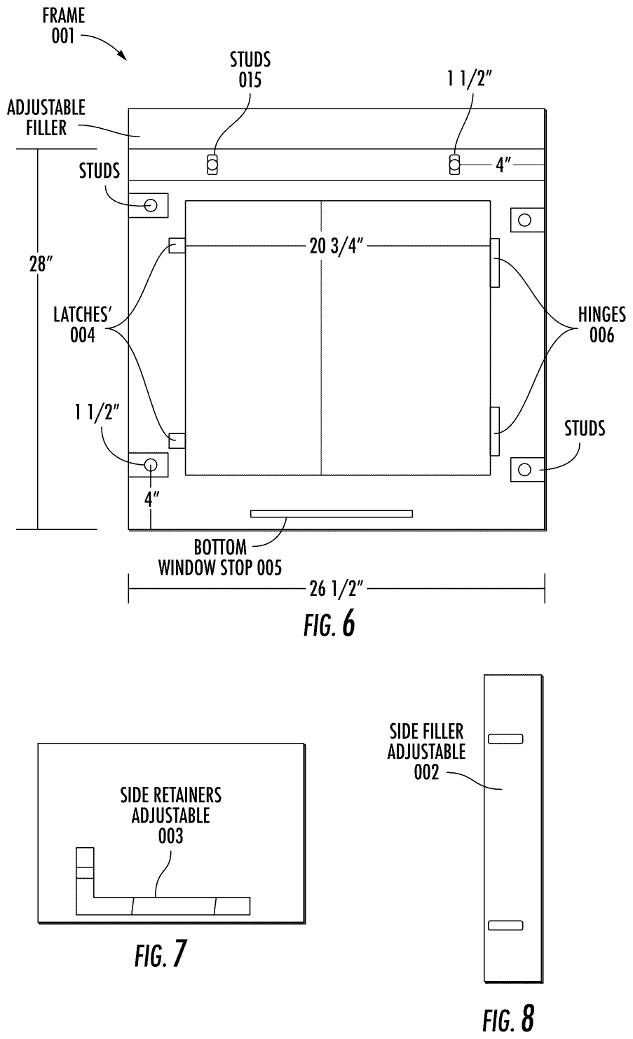

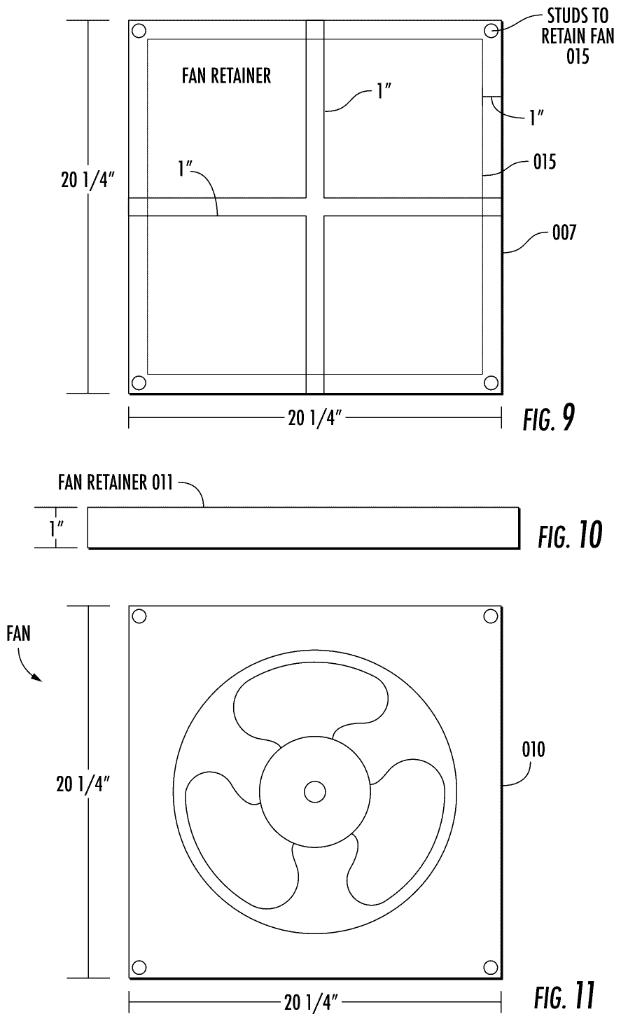

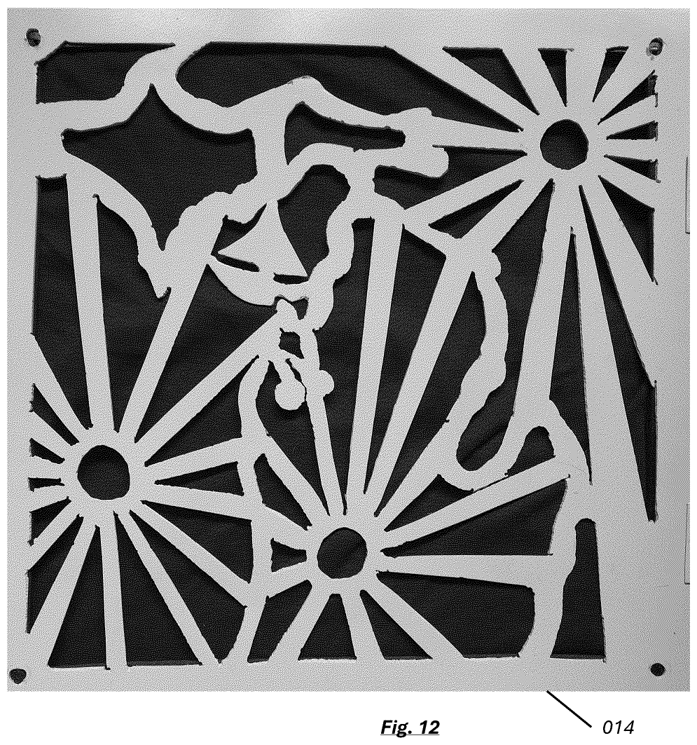

A side retainer bracket 003 (FIGS. 1, 4, and 7) made of steel or similar strength materials is used to attach and reinforce the frame 001 to the sash or any structural opening's framework. Two latches 004 (FIGS. 1 and 6) keep frame 001 (FIGS. 1, 2, and 6) and door 007 (FIGS. 1 and 2) latched and locked together for added safety. At the lower portion of the frame 001, a window stop 005 (FIGS. 1 and 6) made of steel or similar strength materials is added to prevent the lower window from being opened if the system is installed on a window. Hinges 006 (FIGS. 1 and 6) are added to retain and allow the door to swing open. These hinges 006 can be of various types, such as butt hinges, continuous hinges (piano hinges), concealed hinges, pivot hinges, spring hinges, barrel hinges, flush hinges, or strap hinges, depending on the specific requirements and design preferences.

The door 007 (FIGS. 2 and 9), is made of steel or similar strength material, and features a display of an artwork panel 014 (FIG. 1, and alternatively, FIG. 12) and cutouts 015 (FIG. 9) that allow fresh air and natural light to pass through. A fan retainer 011 (FIG. 2) is added to the door 007, holding the fan 010 in place and creating a one inch to four inch cavity between door 007 and fan 010. This cavity can be filled with materials or lights to change the artwork's color or a filter to purify the incoming air. The door 007 also includes a motion alarm 008 that alerts the user with an audible sound, via Bluetooth® telecommunication to an app, or through other wireless technologies such as Wi-Fi, Zigbee®, or Z-Wave®, providing a notification in case of a break-in or severe weather. Zigbee® is a registered trademark of CONNECTIVITY STANDARDS ALLIANCE, a corporation of California, residing at 508 2nd Street, Suite 109B, Davis, California, 95616, United States of America. Z-Wave® is a registered trademark of Z-WAVE ALLIANCE INC., a corporation of Delaware, residing at 3855 SW 153rd Drive, Beaverton, Oregon 97003, United States of America. The motion alarm 008 can also integrate with smart home systems like Amazon® Alexa®, Google Home®, or Apple® HomeKit®, enabling voice alerts and integration with other smart devices in the home for enhanced security and convenience. Amazon® and Alexa® are registered trademarks of Amazon Technologies, Inc., a corporation of Nevada, residing at 410 Terry Avenue North, Seattle, Washington, 98109, United States of America. Google® and Google Home® are registered trademarks of GOOGLE LLC, a limited liability company of Delaware, residing at 1600 Amphitheatre Parkway, Mountain View, California 94043, United States of America. Apple® and HomeKit® are registered trademarks of APPLE INC., a corporation of California, residing at One Apple Park Way, Cupertino, California 95014, United States of America. Additionally, the system has a humidity sensor that notifies the user if it starts raining, allowing the user to close the upper window. This sensor can also connect to weather monitoring systems and provide data to smart home hubs, enabling automated responses such as closing windows, adjusting heating, ventilation and air-conditioning (HVAC) settings, or activating dehumidifiers to maintain indoor air quality and comfort.

The door 007 seals with a foam-type material to restrict all airflow escaping between door 007 and frame 001. Door 007 is connected by two hinges 006 (FIG. 1), allowing it to be opened or removed for cleaning, adding a filter, or inserting colored materials. The motion alarm 008 attached to door 007 notifies occupants of a potential break-in or severe weather. Alarm 008 is powered by a solar panel 009 (FIG. 5) or other power sources provided for the system. The system includes the solar panel 009 to power the motion-sensing alarm and comes with suction cups for attachment to any flat surface and a hook for hanging on any device. Solar panels 009 can vary in types, including monocrystalline, polycrystalline, thin-film, perovskite, bifacial, and organic photovoltaic cells. Monocrystalline cells are known for their high efficiency and durability, while polycrystalline cells are more affordable but slightly less efficient. Thin-film cells offer flexibility and lightweight properties, making them suitable for various surfaces. Perovskite cells are emerging as a cost-effective and efficient option, while bifacial cells capture sunlight from both sides for increased energy yield. Organic photovoltaic cells are lightweight and potentially cheaper to produce, although they currently have lower efficiency and shorter lifespans compared to silicon-based cells.

A variable speed fan assembly 010 (FIGS. 2 and 11) is added and is removable if not needed, attaching to fan retainer 011 to help increase airflow. Fan retainer 011 attached to door 007 holds the fan in place, creating a one inch to four inch cavity between fan 010 and door 007. This cavity can be filled with any material or lights to change the artwork's color, and a filter can be added to purify the air passing through door 007. A window retainer 012 (FIGS. 1 and 3) is attached to the back of frame 001, made in various sizes, shapes, and materials to retain frame 001 to window run channels. Retainer hooks 013 (FIG. 1) are also added to the door 007 so a twenty inch by twenty inch box fan can be hung instead of another fan 010. Studs 015 (FIGS. 2, 6, and 9) may be installed to the door 007 to extend through the frame 001 and to retain the fan 010.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A window security device comprising:
a frame made of a material selected from the group consisting of steel and other materials, the frame being configured to attach to an opening using a sealing material selected from the group consisting of rubber, foam, and similar materials;
an adjustable filler piece made of a material selected from the group consisting of steel and similar materials, the adjustable filler piece being configured to conform to odd-sized openings;
a side retainer bracket made of a material selected from the group consisting of steel and similar strength materials, the side retainer bracket being configured to attach and reinforce the frame to a sash or any structural opening's framework;
two latches configured to keep the frame and a door latched and locked together for added safety;
a window stop made of a material selected from the group consisting of steel and similar strength materials, the window stop being configured to prevent the lower window from opening;
hinges configured to allow the door to swing open, the hinges being attached to the frame and the door;
a door made of a material selected from the group consisting of steel and similar strength materials, the door having a display of artwork, cutouts allowing fresh air and natural light to pass through, and a foam-type sealing material configured to restrict air flow between the door and the frame;
a fan retainer attached to the door, the fan retainer being configured to hold a fan in place and create a cavity between the door and the fan;
a motion alarm attached to the door, the motion alarm being configured to alert occupants of possible break-ins or severe weather, the motion alarm being powered by a solar panel or other power sources;
a variable speed fan assembly configured to be attached to the fan retainer and increase air flow if desired;
a window retainer attached to the back of the frame, the window retainer being made in various sizes, shapes, and types of materials to retain the frame to window run channels; and
retainer hooks attached to the door, the retainer hooks being configured to allow a box fan to be hung instead of another fan.

2. The window security device of claim 1, wherein the frame further comprises rubber or foam material for additional sealing.

3. The window security device of claim 1, wherein the adjustable filler piece is configured to be adjusted manually to fit various opening sizes.

4. The window security device of claim 1, wherein the motion alarm is configured to produce an audible sound upon detecting motion.

5. The window security device of claim 1, further comprising a humidity sensor configured to alert occupants when it is raining outside.

6. The window security device of claim 1, wherein the solar panel is configured to be attached to any flat surface using suction cups or hooks.

7. The window security device of claim 1, wherein the cavity between the door and the fan is adjustable to a depth between one inch and four inches.

8. The window security device of claim 1, further comprising a filter attachable within the cavity for purifying air passing through the door.

9. A door security and air purification system comprising:
a frame attachable to an opening using brackets and a lower bracket configured to lock a lower window shut;
a door attachable to the frame using hinges, the door being made of a material selected from the group consisting of steel and similar strength materials and having a display of artwork;
a motion sensor alarm attached to the door, the motion sensor alarm being configured to alert via Bluetooth® telecommunication to mobile devices;
a custom fit fan attached to the door, the fan having features for controlling temperature, humidity, and on-off switching, and being attached to a fan retainer creating a pocket behind the door;
materials and lighting schemes attachable within the pocket to change the appearance of the artwork or to filter air passing through the door; and
a fan hanger configured to retain a box fan within the pocket.

10. The door security and air purification system of claim 9, wherein the fan is configured to be detachable from the fan retainer.

11. The door security and air purification system of claim 9, wherein the door includes cutouts to allow additional natural light to pass through.

12. The door security and air purification system of claim 9, further comprising a solar panel configured to power the motion sensor alarm.
